(19) United States
(12) Patent Application Publication
(10) Pub. No.: US 2019/0097485 A1
(43) Pub. Date: Mar. 28, 2019

(54) MOTOR

(71) Applicant: Nidec Corporation, Kyoto (JP)

(72) Inventor: Hiroki YAMADA, Kyoto (JP)

(21) Appl. No.: 16/102,816

(22) Filed: Aug. 14, 2018

(30) Foreign Application Priority Data
Sep. 26, 2017 (JP) 2017-184786

(51) Int. Cl. H02K 3/52; H02K 3/47; G11B 19/20; H02K 5/24; H02K 5/16

(52) U.S. Cl. CPC H02K 3/524; H02K 3/47; H02K 5/163; H02K 5/24; G11B 19/2009

(57) ABSTRACT

A motor includes a support portion arranged to hold a stator and a bearing. The support portion includes a bearing holding portion arranged to extend upward along a central axis, and arranged to hold the bearing with a radially inner surface thereof; and a stator holding portion being tubular, arranged to project upward from an upper surface of the bearing holding portion, and arranged to hold a radially inner surface of the stator with a radially outer surface thereof. An axially lower portion of the stator holding portion includes a decreased thickness portion where the radial thickness of the stator holding portion is smaller than at another portion of the stator holding portion at another axial position.

### CROSS REFERENCE TO RELATED APPLICATIONS

This application claims the benefit of priority to Japanese Patent Application No. 2017-184786 filed on Sep. 26, 2017. The entire contents of this application are hereby incorporated herein by reference.

### BACKGROUND OF THE INVENTION

### 1. Field of the Invention

The present invention relates to a motor.

### 2. Description of the Related Art

A hard disk is caused to rotate by, for example, a spindle motor described in JP-A 1996-228465. The spindle motor described in JP-A 1996-228465 includes a stator core and a frame. The stator core is press fitted to the frame with a small amount of force to position and temporarily fix the stator core with respect to the frame, and an adhesive is thereafter applied into a gap between the frame and the stator core to finally fix the stator core and the frame to each other. This press fitting using a small amount of force for temporary fixing and the subsequent application of the adhesive for final fixing allow the stator core to be securely fixed to the frame.

### SUMMARY OF THE INVENTION

When the spindle motor is in operation, a vibration is generated from a stator. This vibration is transferred to the frame, resulting in increased vibration of a device as a whole. In the spindle motor described in JP-A 1996-228465, the stator core is securely fixed to the frame, allowing the vibration to be transferred from the stator to the frame, which may result in increased vibration of the device as a whole.

Accordingly, the present invention has been conceived to provide a motor that is able to achieve a reduction in vibration of a device as a whole.

A motor according to a preferred embodiment of the present invention includes a shaft arranged to extend along a central axis extending in a vertical direction, and arranged to rotate about the central axis; a bearing arranged to rotatably support the shaft; a hub fixed to an upper end portion of the shaft; a rotor magnet attached to the hub; a stator arranged radially opposite to the rotor magnet; and a support portion arranged to hold the bearing and the stator. The support portion includes a bearing holding portion arranged to extend upward along the central axis, and arranged to hold the bearing with a radially inner surface thereof; and a stator holding portion being tubular, arranged to project upward from an upper surface of the bearing holding portion, and arranged to hold a radially inner surface of the stator with a radially outer surface thereof. An axially lower portion of the stator holding portion includes a decreased thickness portion where a radial thickness of the stator holding portion is smaller than at another portion of the stator holding portion at another axial position.

The motor according to the above preferred embodiment of the present invention is able to achieve a reduction in vibration of a device as a whole.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view of a motor according to a preferred embodiment of the present invention.

FIG. 2 is a sectional view of the motor illustrated in FIG. 1 taken along a plane including a central axis.

FIG. 3 is a sectional view illustrating an area where a stator and a stator holding portion of the motor illustrated in FIG. 2 are fixed to each other in an enlarged form.

FIG. 4 is a sectional view illustrating an area where a stator and a stator holding portion of a motor according to another preferred embodiment of the present invention are fixed to each other in an enlarged form.

FIG. 5 is a sectional view illustrating an area where a stator and a stator holding portion of a motor according to yet another preferred embodiment of the present invention are fixed to each other in an enlarged form.

FIG. 6 is a sectional view illustrating an area where a stator and a stator holding portion of a motor according to yet another preferred embodiment of the present invention are fixed to each other in an enlarged form.

FIG. 7 is a sectional view illustrating an area where a stator and a stator holding portion of a motor according to yet another preferred embodiment of the present invention are fixed to each other in an enlarged form.

### DETAILED DESCRIPTION OF THE PREFERRED EMBODIMENTS

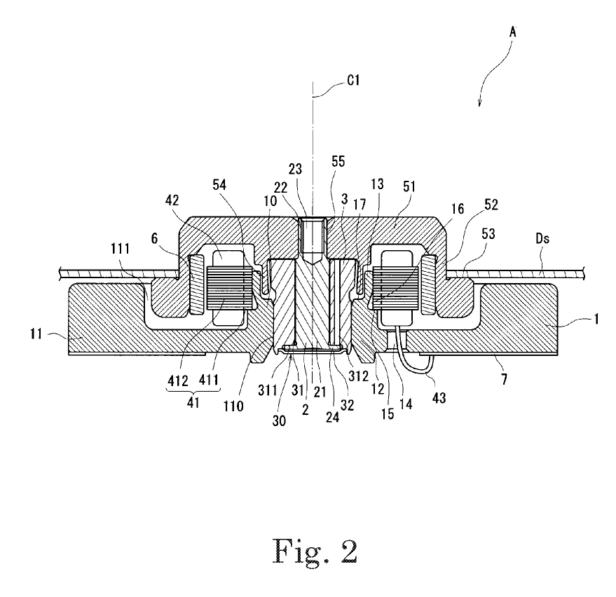

Hereinafter, preferred embodiments of the present invention will be described in detail with reference to the accompanying drawings. It is assumed herein that a direction parallel to a central axis C1 of a motor is referred to by the term “axial direction”, “axial”, or “axially”, that directions perpendicular to the central axis C1 are each referred to by the term “radial direction”, “radial”, or “radially”, and that a direction along a circular arc centered on the central axis C1 is referred to by the term “circumferential direction”, “circumferential”, or “circumferentially”. It is also assumed herein that a motor A illustrated in FIG. 2 is used as a reference to define an upper side and a lower side in a vertical direction along the central axis C1, and the shape of each member or portion and relative positions of different members or portions will be described based on the above assumption. It should be noted, however, that the above definition of the vertical direction and the upper and lower sides is made simply for the sake of convenience in description, and is not meant to restrict relative positions or directions of different members or portions of the motor A when in use.

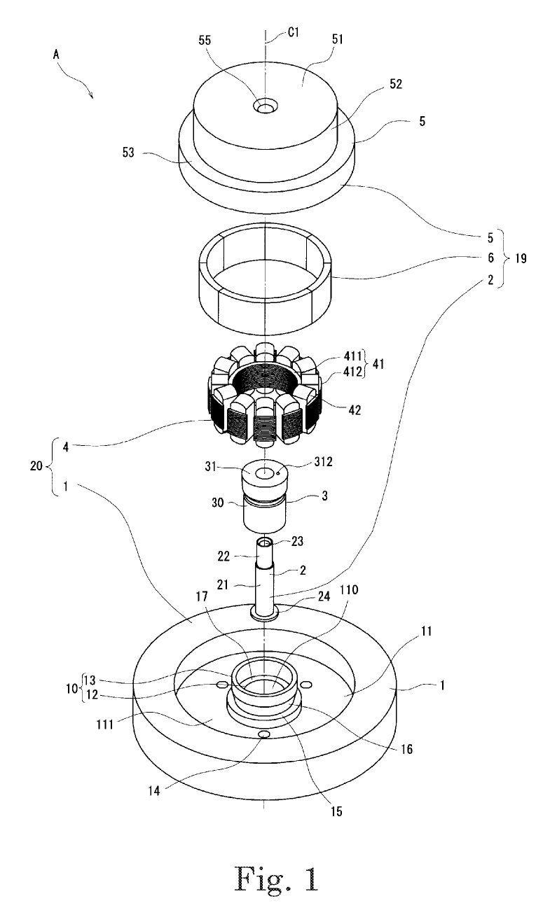

Hereinafter, a preferred embodiment of the present invention will be described with reference to the accompanying drawings. FIG. 1 is an exploded perspective view of the motor A according to a first preferred embodiment of the present invention. FIG. 2 is a sectional view of the motor A illustrated in FIG. 1 taken along a plane including the central axis C1. The motor A according to the present preferred embodiment is a so-called spindle motor arranged to rotate a disk-shaped recording disk Ds, such as, for example, a hard disk. In the motor A, a rotor portion 19 is supported through a bearing 30 to be rotatable with respect to a stator portion 20. That is, the rotor portion 19 is supported to be rotatable about the central axis C1 with respect to the stator portion 20.

Referring to FIGS. 1 and 2, the motor A according to the present preferred embodiment includes a base 1, a shaft 2, a sleeve 3, a stator 4, a hub 5, a rotor magnet 6, and a circuit board 7. The rotor portion 19 includes the shaft 2, the hub 5, and the rotor magnet 6. The stator portion 20 includes the base 1 and the stator 4. The bearing 30 includes the sleeve 3.

In the rotor portion 19, the shaft 2 is fixed to a central portion of the hub 5. In addition, the rotor magnet 6 is arranged inside of the hub 5, and both the shaft 2 and the rotor magnet 6 are centered on the central axis C1.

Referring to FIGS. 1 and 2, the shaft 2 is columnar. The shaft 2 includes a first shaft portion 21, a second shaft portion 22, a screw hole 23, and a flange portion 24. The shaft 2 is made of a metal. The shaft 2 is arranged to extend along the central axis C1. The shaft 2 is arranged to extend along the central axis extending in the vertical direction, and is arranged to rotate about the central axis C1.

The first shaft portion 21 is arranged to extend in an axial direction. The second shaft portion 22 is cylindrical, and is arranged axially above the first shaft portion 21. The second shaft portion 22 is arranged to have a diameter smaller than that of the first shaft portion 21. The first and second shaft portions 21 and 22 are made of the same material, and are defined integrally with each other. The screw hole 23 is recessed downward from an axially upper surface of the shaft 2. An inner surface of the screw hole 23 includes a female screw. In addition, the flange portion 24 is arranged to extend radially outward at an axially lower end portion of the shaft 2. The flange portion 24 is in the shape of a disk.

The shaft 2 is fixed to the central portion of the hub 5. The hub 5 and the shaft 2 are arranged to rotate together. That is, the hub 5 is fixed to the shaft 2. Referring to FIGS. 1 and 2, the hub 5 includes a hub top plate portion 51, a hub tubular portion 52, a disk flange 53, a labyrinth projecting portion 54, and a shaft fixing hole 55.

The hub top plate portion 51 is arranged to extend radially. The hub top plate portion 51 is circular when viewed in the axial direction. The hub tubular portion 52 is arranged to extend axially downward from a radially outer edge of the hub top plate portion 51. The hub tubular portion 52 is cylindrical. The disk flange 53 is arranged to extend radially outward from an axially lower end portion of the hub tubular portion 52. The disk flange 53 is circular when viewed in the axial direction. The hub top plate portion 51, the hub tubular portion 52, and the disk flange 53 are made of the same material, and are molded integrally with each other.

An axially upper surface of the disk flange 53 is a flat surface perpendicular to the central axis C1. The disk Ds is arranged to be in contact with the axially upper surface of the disk flange 53. The disk Ds is then fixed to the hub 5. Thus, the disk Ds is fixed so as to be perpendicular to the central axis C1, i.e., a rotation axis. Then, rotation of the hub 5 causes the disk Ds to rotate. Note that, while the motor A according to the present preferred embodiment includes only one disk Ds, this is not essential to the present invention. In a motor according to another preferred embodiment of the present invention, a plurality of disks Ds may be fixed such that the disks Ds are spaced from one another in a direction parallel to the central axis C1. Even in this case, all the disks Ds are fixed so as to be perpendicular to the central axis C1.

The shaft fixing hole 55 is a through hole defined in a center of the hub top plate portion 51 when viewed in the axial direction, and arranged to pass through the hub top plate portion 51 in the axial direction. The second shaft portion 22 of the shaft 2 is inserted into and fixed in the shaft fixing hole 55. The second shaft portion 22 is fixed in the shaft fixing hole 55 through, for example, press fitting.

The labyrinth projecting portion 54 is arranged to project downward from a lower surface of the hub top plate portion 51. The labyrinth projecting portion 54 is tubular, and the labyrinth projecting portion 54 is arranged to have an inside diameter greater than a diameter of the shaft fixing hole 55. Referring to FIG. 2, the labyrinth projecting portion 54 is arranged radially outward of a portion of an axially upper end portion of a sleeve body 31, which will be described below, of the bearing 30. The labyrinth projecting portion 54 and the hub top plate portion 51 are made of the same material, and are molded integrally with each other. That is, the hub 5 includes the labyrinth projecting portion 54, which is a tubular body extending downward along the central axis C1, and which is arranged radially opposite to each of the bearing 30 and a stator holding portion 13 with a gap therebetween.

Referring to FIG. 2, the rotor magnet 6 is arranged on an inner surface of the hub tubular portion 52. The rotor magnet 6 is cylindrical, and is arranged to extend along the central axis C1. A radially inner surface of the rotor magnet 6 is arranged radially opposite to a radially outer surface of the stator 4 with a gap therebetween. The rotor magnet 6 includes a plurality of pairs of magnetic poles, each pair including a north pole and a south pole. The rotor magnet 6 may be defined by a cylindrical magnetic body including north and south poles arranged to alternate with each other in a circumferential direction, or alternatively, a plurality of magnets arranged in the circumferential direction may be used as the rotor magnet 6. The rotor magnet 6 is fixed inside of the hub tubular portion 52 through, for example, press fitting. Note that the method for fixing the rotor magnet 6 is not limited to the press fitting, and that adhesion, welding, a mechanical fixing method, and so on may be adopted to fix the rotor magnet 6. In the motor A according to the present preferred embodiment, the rotor magnet 6 includes eight magnetic poles.

The stator portion 20 includes the base 1 and the stator 4. The stator 4 is held by the base 1 such that the radially outer surface of the stator 4 is arranged radially opposite to the radially inner surface of the rotor magnet 6 of the rotor portion 19 with the gap therebetween.

Referring to FIGS. 1 and 2, the base 1 is a bottom portion arranged to cover an axially lower end of the motor A. The base 1 includes a support portion 10, a base plate 11, a sleeve attachment portion 12, the stator holding portion 13, and lead wire insert holes 14. The base plate 11 is circular, that is, in the shape of a disk, when viewed in the axial direction. A base recessed portion 111 recessed axially downward is defined in an axially upper surface of the base plate 11. A section of the base recessed portion 111 which is perpendicular to the central axis C1 is circular, and an axially lower end portion of the hub 5 is rotatably accommodated in the base recessed portion 111. That is, the base recessed portion 111 is cylindrical, and the axially lower end portion of the hub 5 is arranged to rotate about the central axis C1 inside of the base recessed portion 111.

Note that, although the base plate 11 of the base 1 is in the shape of a disk in the present preferred embodiment, the base plate 11 may not necessarily be in the shape of a disk. For example, the base 1 may alternatively be in the shape of a polygon, such as, for example, a quadrilateral or a hexagon, or in the shape of an ellipse or the like, when viewed in the axial direction. A wide variety of shapes may be adopted for the base 1 in accordance with a device to which the motor A is to be attached. Also note that the base recessed portion 111 may not necessarily be cylindrical, but may alternatively be in any other desirable shape that allows the axially lower end portion of the hub 5 to be rotatably accommodated therein.

A through hole 110, which is arranged to pass through the base plate 11 in the axial direction, is defined in a center of the base plate 11. The support portion 10 is cylindrical, and is arranged to project axially upward from a periphery of the through hole 110. The support portion 10 and the base plate 11 may be made of the same material and be defined integrally with each other, or alternatively, the support portion 10 may be a member separate from the base plate 11 and fixed to the base plate 11. Notice that, in the motor A, the through hole 110 is in a center of the base recessed portion 111.

The support portion 10 includes the sleeve attachment portion 12 and the stator holding portion 13. The sleeve body 31, which will be described below, of the bearing 30 is held by a radially inner surface of the sleeve attachment portion 12. The bearing 30 is held by the sleeve attachment portion 12 through a contact of the sleeve body 31 with the radially inner surface of the sleeve attachment portion 12. The stator holding portion 13 is tubular, and is arranged to project axially upward from an axially upper surface of the sleeve attachment portion 12. The stator holding portion 13 is arranged to be in contact with an inner surface of a stator core 41, which will be described below, of the stator 4 to hold the stator 4. That is, the support portion 10 is arranged to hold both the bearing 30 and the stator 4. In addition, the support portion 10 includes the sleeve attachment portion 12, which is arranged to extend upward along the central axis C1, and which is arranged to hold the bearing 30 with the radially inner surface thereof, and the stator holding portion 13, which is tubular, arranged to project upward from the upper surface of the sleeve attachment portion 12, and arranged to hold a radially inner surface of the stator 4 with a radially outer surface thereof.

Referring to FIG. 2, an axially upper portion of the stator 4 is arranged to be in contact with the stator holding portion 13. That is, at least a portion of the stator 4 is held by the stator holding portion 13.

Each lead wire insert hole 14 is arranged at a bottom surface of the base recessed portion 111. Each lead wire insert hole 14 is a through hole arranged to pass through the base 1 in the axial direction. Lead wires 43, which are connected to coils 42 of the stator 4, which will be described below, are arranged to pass through the lead wire insert holes 14. In addition, the circuit board 7 is attached to an axially lower surface of the base 1. Each lead wire 43 is inserted into the corresponding lead wire insert hole 14 through an axially upper opening thereof, and is drawn out of the corresponding lead wire insert hole 14 through an axially lower opening thereof. The lead wire 43 drawn out is then connected to the circuit board 7. Note that, although the number of lead wire insert holes 14 is three in the present preferred embodiment, only one lead wire insert hole may be provided in another preferred embodiment of the present invention.

The stator 4 is held by the stator holding portion 13 of the base 1. The stator 4 includes the stator core 41, the coils 42, and the lead wires 43.

The stator core 41 is defined by laminated silicon steel sheets. Referring to FIG. 1, the stator core 41 includes an annular core back portion 411 and tooth portions 412. Referring to FIG. 2, the stator core 41 is defined by plate-shaped members placed one upon another in the axial direction. That is, the stator core 41 is a laminated body. Note, however, that this is not essential to the present invention.

The core back portion 411 is annular, and is arranged to extend in the axial direction. An inner surface of the core back portion 411 is arranged to be in contact with the outer surface of the stator holding portion 13, so that the core back portion 411, hence the stator 4, is held by the stator holding portion 13. The stator holding portion 13 and the core back portion 411 are fixed to each other through press fitting. Note that other fixing methods than the press fitting, such as adhesion, deposition, welding, and the like, may be widely adopted to securely fix the stator holding portion 13 and the core back portion 411 to each other.

Each tooth portion 412 is arranged to project radially outward from a radially outer surface of the core back portion 411. The stator core 41 includes twelve of the tooth portions 412. The tooth portions 412 are arranged at regular intervals in the circumferential direction. The stator 4 has twelve slots. The motor A according to the present preferred embodiment includes the rotor magnet 6 with eight magnetic poles, and the stator 4 with twelve slots. That is, the motor A is an outer-rotor motor having eight poles and twelve slots.

Each tooth portion 412 of the stator core 41 is covered with an insulator, which is not shown. Each tooth portion 412 covered with the insulator has one of the coils 42 defined by a conducting wire wound therearound. The insulator provides isolation between the stator core 41 and each coil 42. The coil 42 is arranged around each of the tooth portions 412 of the stator core 41. That is, the stator 4 includes twelve of the coils 42. The twelve coils 42 included in the stator 4 are divided into three groups (hereinafter referred to as three phases) which differ in timing of supply of an electric current. The three phases are defined as a U phase, a V phase, and a W phase, respectively. That is, the stator 4 includes four U-phase windings, four V-phase windings, and four W-phase windings. Hereinafter, the windings of the three phases will be simply referred to collectively as the coils 42.

The lead wires 43 are arranged to electrically connect the coils 42 of the U, V, and W phases to a circuit (not shown) mounted on the circuit board 7. Referring to FIG. 2, each lead wire 43 is drawn out downwardly from an axially lower side of the stator 4. The lead wire 43 is then passed through the corresponding lead wire insert hole 14 of the base 1 to be drawn out downwardly of the base 1, and is electrically connected to a wiring pattern (not shown) on the circuit board 7. Each lead wire 43 is connected to the wiring pattern through soldering. Note, however, that each lead wire 43 may be connected to the wiring pattern using a connection member, such as, for example, a connector, instead of through the soldering.

Next, the bearing 30, which is arranged to support the rotor portion 19 such that the rotor portion 19 is rotatable with respect to the stator portion 20, will now be described below. The bearing 30 is a fluid dynamic bearing using a fluid. The bearing 30 is arranged to rotatably support the shaft 2. The bearing 30 includes the sleeve body 31 and a seal cap 32. Each of the sleeve body 31 and the seal cap 32 is made of, for example, stainless steel or the like. The sleeve body 31 and the seal cap 32 together define the sleeve 3.

The sleeve body 31 is cylindrical, and is centered on the central axis C1. The sleeve body 31 has, at a lower end portion thereof, a shoulder portion 311 recessed upward. The flange portion 24 of the shaft 2 is accommodated inside of the shoulder portion 311. In addition, the seal cap 32 is attached to the shoulder portion 311 to cover a lower side of the flange portion 24. The seal cap 32 is fixed by a fixing method using an adhesive or the like.

The sleeve body 31 includes a circulation hole 312 arranged to pass therethrough in the axial direction at a position radially outward of the central axis C1. The circulation hole 312 is in communication with a gap between the seal cap 32 and the shoulder portion 311 at a lower portion of the sleeve body 31.

Minute gaps are defined between an inner circumferential surface of the sleeve body 31 and an outer circumferential surface of the shaft 2, between the sleeve body 31 and an upper surface and an outer circumferential surface of the flange portion 24, and between an upper surface of the seal cap 32 and a lower surface of the flange portion 24. A lubricating oil as the fluid is continuously arranged in these minute gaps. Thus, the bearing 30 of the motor A is defined by the sleeve body 31, the seal cap 32, the shaft 2, and the lubricating oil.

The flange portion 24 and a portion of the shaft 2 which is radially opposite to an inner surface of the sleeve body 31 include grooves defined therein. When the shaft 2 rotates, these grooves produce dynamic pressures in the lubricating oil. The dynamic pressures cause the lubricating oil to circulate through the gap between the inner surface of the sleeve body 31 and the outer surface of the shaft 2 and a gap between an axially upper end surface of the sleeve body 31 and the axially lower surface of the hub top plate portion 51 of the hub 5. As a result, the shaft is supported through the lubricating oil while being out of contact with the sleeve body 31, allowing the rotor portion 19 to rotate with respect to the stator portion 20 with high precision and reduced noise.

That is, the bearing 30 includes a so-called radial bearing which includes the lubricating oil circulating through the gap between the outer surface of the shaft 2 and the sleeve body 31, and which is arranged to support rotation of the shaft 2. In addition, the bearing 30 includes a so-called thrust bearing which includes the lubricating oil circulating through the gap between the sleeve body 31 and the axially lower surface of the hub top plate portion 51, and which is arranged to support the shaft 2 in the axial direction.

The motor A according to the present preferred embodiment has the above-described structure. Next, important portions of the motor A according to the present preferred embodiment will now be described below with reference to the accompanying drawings.

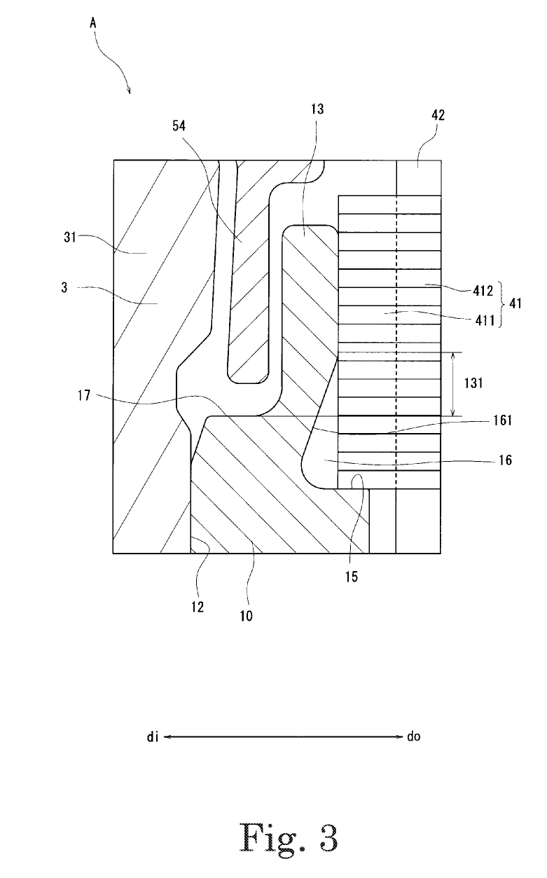

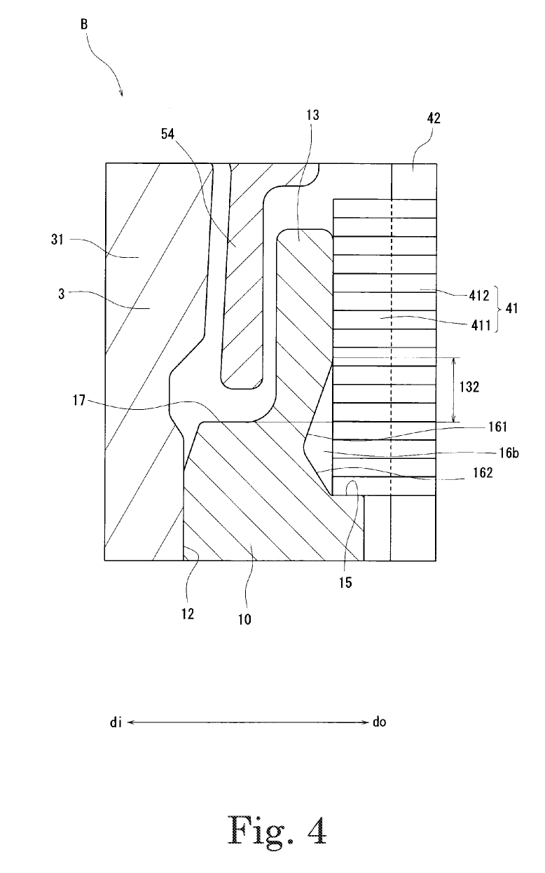

FIG. 3 is a sectional view illustrating an area where the stator 4 and the stator holding portion 13 of the motor A illustrated in FIG. 2 are fixed to each other in an enlarged form. In FIG. 3, the vertical direction corresponds to the axial direction, and the upper side corresponds to the upper side in the axial direction. In addition, the left-right direction corresponds to a radial direction, and the right side and the left side correspond to an outer side do and an inner side di, respectively, in the radial direction. Also in each of FIGS. 4, 5, 6, and 7, the same definitions are made with respect to the axial and radial directions.

In FIG. 3, the stator holding portion 13 and the stator core 41 of the motor A are shown in an enlarged form. Referring to FIG. 3, the stator holding portion 13 is a tubular body arranged to extend axially upward from the upper surface of the sleeve attachment portion 12 of the base 1. A lower end portion of the core back portion 411 of the stator core 41 is arranged to be in contact with a radially outer portion of the sleeve attachment portion 12, while an upper portion of the core back portion 411 is arranged to be in contact with the stator holding portion 13.

A radially outer portion of the support portion 10 includes a stator contact surface 15, which is a surface perpendicular to the central axis C1 and arranged to be in contact with an axially lower surface of the core back portion 411. The outside diameter of the support portion 10 is arranged to be smaller axially above the stator contact surface 15 than axially below the stator contact surface 15. That is, in the support portion 10, the stator contact surface 15 defines a shoulder portion projecting radially outward relative to an axially upper portion of the support portion 10. In addition, a radially outer surface of the support portion 10 includes an annular outer recessed portion 16 recessed radially inward. The outer recessed portion 16 is defined axially above the stator contact surface 15.

Referring to FIG. 3, an axially upper portion of the outer recessed portion 16 includes a first outer slanting surface 161 arranged to extend radially inward with decreasing height. That is, the outer recessed portion 16 includes the first outer slanting surface 161 arranged to extend radially inward with decreasing height. Then, in the outer recessed portion 16, the first outer slanting surface 161 and the stator contact surface 15 are joined to each other. That is, the outer recessed portion 16 includes the first outer slanting surface 161 and a portion of the stator contact surface 15. That is, the support portion 10 includes the stator contact surface 15, which is perpendicular to the central axis C1 and is arranged to be in contact with an axially lower surface of the stator 4, and the stator contact surface 15 and the first outer slanting surface 161 are joined to each other in the outer recessed portion 16.

An axially lower portion of the outer recessed portion 16 is arranged to overlap with the sleeve attachment portion 12 when viewed in the radial direction. That is, the axially lower portion of the outer recessed portion 16 is defined in a radially outer surface of the sleeve attachment portion 12. In addition, the axially upper portion of the outer recessed portion 16 is arranged to overlap with an axially lower portion of the stator holding portion 13 when viewed in the radial direction. That is, the axially upper portion of the outer recessed portion 16 is defined in a radially outer surface of the axially lower portion of the stator holding portion 13. That is, the support portion 10 includes the annular outer recessed portion 16, which is recessed radially inward, and at least a portion of which is defined radially outside of the stator holding portion 13.

A portion of the axially lower portion of the stator holding portion 13 which overlaps with the outer recessed portion 16 when viewed in the radial direction is arranged to have a radial thickness smaller than that of another portion of the stator holding portion 13 at another axial position. That is, the portion of the lower portion of the stator holding portion 13 which overlaps with the outer recessed portion 16 when viewed in the radial direction is a decreased thickness portion 131. That is, the axially lower portion of the stator holding portion 13 includes the decreased thickness portion 131, where the radial thickness of the stator holding portion 13 is smaller than at another portion of the stator holding portion 13 at another axial position. In addition, the decreased thickness portion 131 is arranged to overlap with the outer recessed portion 16 when viewed in the radial direction.

Referring to FIG. 3, the stator 4 is held by the stator holding portion 13. Once the motor A is driven, the stator core 41 will vibrate. A vibration of the stator core 41 is transferred to the stator holding portion 13, and is transferred to the support portion 10, i.e., to the base 1.

In the motor A according to the present preferred embodiment, the axially lower portion of the stator holding portion 13 includes the decreased thickness portion 131. The decreased thickness portion 131 is more prone to deformation and has a higher tendency to follow the vibration and a greater flexibility than an adjacent portion of the stator holding portion 13. Accordingly, the vibration transferred from the stator core 41 is attenuated by a deformation of the decreased thickness portion 131, so that a reduction in vibration transferred to the support portion 10 is achieved. In addition, the higher tendency of the decreased thickness portion 131 to follow the vibration and the greater flexibility of the decreased thickness portion 131 contribute to reducing variations in the vibration transferred.

In addition, effective vibration control can be accomplished in the support portion 10, that is, in the base 1, by the reduction in the vibration transferred and the reduced variations in the vibration transferred. As a result, a reduction in vibration of the motor A as a whole is achieved. Note that, although the first outer slanting surface 161 and the stator contact surface 15 are joined to each other to define the outer recessed portion 16 in the present preferred embodiment, this is not essential to the present invention. For example, the outer recessed portion 16 may alternatively be arranged to have a rectangular or semicircular section when viewed in the circumferential direction.

FIG. 4 is a sectional view illustrating an area where a stator and a stator holding portion 13 of a motor B according to another preferred embodiment of the present invention are fixed to each other in an enlarged form. The motor B illustrated in FIG. 4 is similar in structure to the motor A according to the first preferred embodiment except in the shape of an outer recessed portion 16b. Accordingly, portions of the motor B according to the present preferred embodiment which have their equivalents in the motor A are denoted by the same reference numerals as those of their equivalents in the motor A, and detailed descriptions of such portions will be omitted.

Referring to FIG. 4, an axially lower portion of the outer recessed portion 16b includes a second outer slanting surface 162 arranged to extend radially inward with increasing height. Then, in the outer recessed portion 16b, a first outer slanting surface 161 and the second outer slanting surface 162 are joined to each other. That is, the outer recessed portion 16b includes the first outer slanting surface 161 and the second outer slanting surface 162. In addition, the second outer slanting surface 162 and a stator contact surface 15 are joined to each other. That is, the outer recessed portion 16b includes the second outer slanting surface 162, which is arranged to extend radially inward with increasing height, and in the outer recessed portion 16b, the first outer slanting surface 161 and the second outer slanting surface 162 are joined to each other.

An axially upper portion of the outer recessed portion 16b is arranged to overlap with an axially lower portion of the stator holding portion 13 when viewed in the radial direction. That is, the axially upper portion of the outer recessed portion 16b is defined in a radially outer surface of the axially lower portion of the stator holding portion 13. Then, a portion of the axially lower portion of the stator holding portion 13 which overlaps with the outer recessed portion 16b when viewed in the radial direction is a decreased thickness portion 132. Because of provision of the decreased thickness portion 132, a vibration of a stator core 41 is not easily transferred to a support portion 10, and a reduction in variations in the vibration transferred is achieved. Thus, not only a reduction in vibration is achieved, but also effective vibration control can be accomplished in the support portion 10, that is, in a base 1. As a result, a reduction in vibration of the motor B as a whole is achieved.

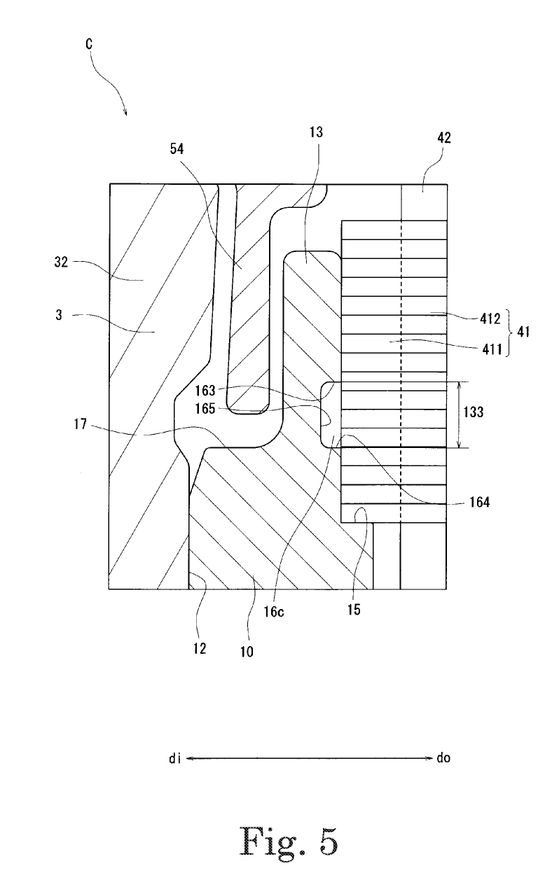

FIG. 5 is a sectional view illustrating an area where a stator and a stator holding portion 13 of a motor C according to yet another preferred embodiment of the present invention are fixed to each other in an enlarged form. The motor C illustrated in FIG. 5 is similar in structure to the motor A according to the first preferred embodiment except in the shape of an outer recessed portion 16c. Accordingly, portions of the motor C according to the present preferred embodiment which have their equivalents in the motor A are denoted by the same reference numerals as those of their equivalents in the motor A, and detailed descriptions of such portions will be omitted.

Referring to FIG. 5, the outer recessed portion 16c includes an upper surface 163 perpendicular to a central axis C1, a lower surface 164 perpendicular to the central axis C1 and arranged below the upper surface 163, and a joining surface 165 being cylindrical and arranged to join the upper surface 163 and the lower surface 164 to each other. That is, a vertical section of the outer recessed portion 16c taken along a plane including the central axis C1 has a rectangular sectional shape. In addition, the lower surface 164 is arranged to overlap with an axially lower portion of the stator holding portion 13 when viewed in the radial direction. That is, the outer recessed portion 16c is an annular recessed portion recessed radially inward in a radially outer surface of the stator holding portion 13. Then, a portion of the stator holding portion 13 which overlaps with the outer recessed portion 16c when viewed in the radial direction is a decreased thickness portion 133. Because of provision of the decreased thickness portion 133, a vibration of a stator core 41 is not easily transferred to a support portion 10, and a reduction in variations in the vibration transferred is achieved. Thus, not only a reduction in vibration is achieved, but also effective vibration control can be accomplished in the support portion 10, that is, in a base 1. As a result, a reduction in vibration of the motor C as a whole is achieved.

Note that, similarly to the outer recessed portions 16 and 16b illustrated in FIGS. 3 and 4, respectively, the outer recessed portion 16c may be defined in outer surfaces of both a sleeve attachment portion 12 and the stator holding portion 13. In other words, the outer recessed portion may be defined at any desirable position as long as the decreased thickness portion is defined at a position at which an axially lower end portion of the stator holding portion 13 and the sleeve attachment portion 12 are joined to each other.

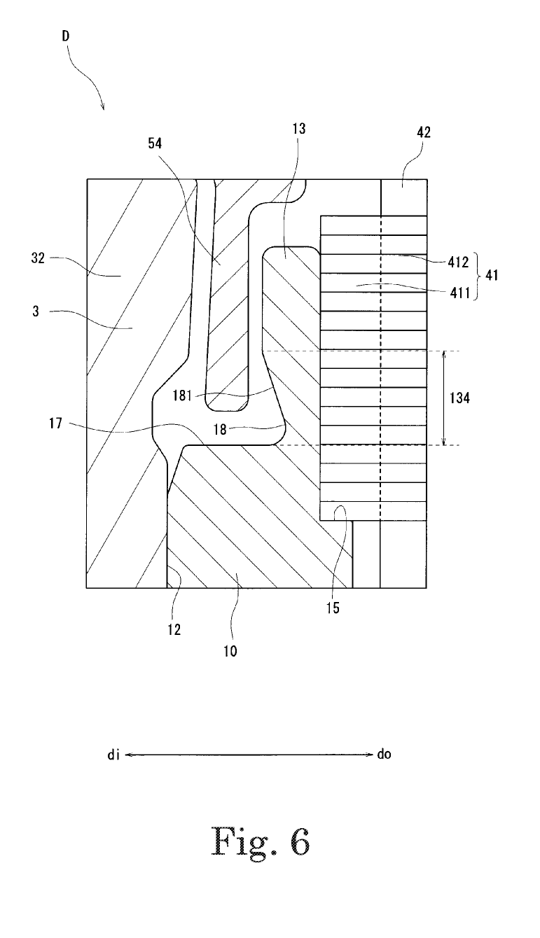

FIG. 6 is a sectional view illustrating an area where a stator and a stator holding portion 13 of a motor D according to yet another preferred embodiment of the present invention are fixed to each other in an enlarged form. The motor D illustrated in FIG. 6 is similar in structure to the motor A according to the first preferred embodiment except that an inner recessed portion 18 is provided in place of the outer recessed portion 16. Accordingly, portions of the motor D according to the present preferred embodiment which have their equivalents in the motor A are denoted by the same reference numerals as those of their equivalents in the motor A, and detailed descriptions of such portions will be omitted.

An axially upper end of a sleeve attachment portion 12 includes an opposed surface 17 arranged opposite to an axially lower surface of a labyrinth projecting portion 54. That is, a support portion 10 includes the opposed surface 17, which is arranged opposite to an axially lower end surface of the labyrinth projecting portion 54, on a radially inner side. In addition, a radially inner surface of the stator holding portion 13 includes the inner recessed portion 18, which is annular and is recessed radially outward. That is, the support portion 10 includes the inner recessed portion 18, which is annular, is recessed radially outward, and is defined radially inside of the stator holding portion 13.

Referring to FIG. 6, an axially upper portion of the inner recessed portion 18 includes a first inner slanting surface 181 arranged to extend radially outward with decreasing height. That is, the inner recessed portion 18 includes the first inner slanting surface 181 arranged to extend radially outward with decreasing height. Then, in the inner recessed portion 18, the first inner slanting surface 181 and the opposed surface 17 are joined to each other. That is, in the inner recessed portion 18, the opposed surface 17 and the first inner slanting surface 181 are joined to each other. In addition, the inner recessed portion 18 includes the first inner slanting surface 181 and a portion of the opposed surface 17.

The inner recessed portion 18 is arranged to overlap with an axially lower portion of the stator holding portion 13 when viewed in the radial direction. That is, the axially upper portion of the inner recessed portion 18 is defined in a radially inner surface of the axially lower portion of the stator holding portion 13. A portion of the axially lower portion of the stator holding portion 13 which overlaps with the inner recessed portion 18 when viewed in the radial direction is arranged to have a radial thickness smaller than that of another portion of the stator holding portion 13 at another axial position. That is, the portion of the axially lower portion of the stator holding portion 13 which overlaps with the inner recessed portion 18 when viewed in the radial direction is a decreased thickness portion 134. That is, the decreased thickness portion 134 is arranged to overlap with the inner recessed portion 18 when viewed in the radial direction.

In the motor D, the stator holding portion 13 includes the decreased thickness portion 134. Thus, a vibration of a stator core 41 is attenuated by a deformation of the decreased thickness portion 134, so that a reduction in vibration transferred to the support portion 10 is achieved. In addition, a tendency of the decreased thickness portion 134 to be relatively easily deformed contributes to reducing variations in the vibration transferred.

In addition, effective vibration control can be accomplished in the support portion 10, that is, in a base 1, by the reduction in the vibration transferred and the reduced variations in the vibration transferred. As a result, a reduction in vibration of the motor D as a whole is achieved.

Note that, although the first inner slanting surface 181 and the opposed surface 17 are joined to each other to define the inner recessed portion 18 in the present preferred embodiment, this is not essential to the present invention. For example, the inner recessed portion 18 may alternatively be arranged to have a rectangular or semicircular section when viewed in the circumferential direction.

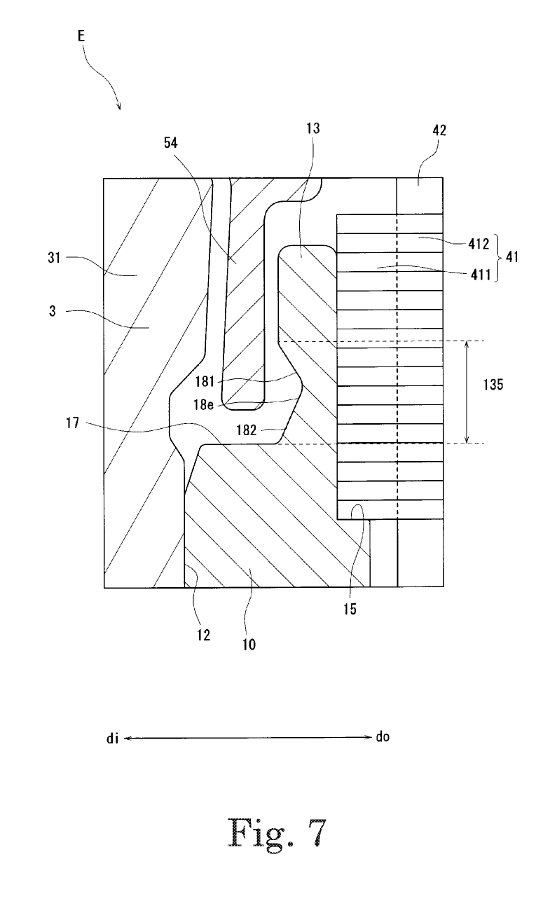

FIG. 7 is a sectional view illustrating an area where a stator and a stator holding portion 13 of a motor E according to yet another preferred embodiment of the present invention are fixed to each other in an enlarged form. The motor E illustrated in FIG. 7 is similar in structure to the motor D according to the fourth preferred embodiment except in the shape of an inner recessed portion 18e. Accordingly, portions of the motor E according to the present preferred embodiment which have their equivalents in the motor D are denoted by the same reference numerals as those of their equivalents in the motor D, and detailed descriptions of such portions will be omitted.

Referring to FIG. 7, an axially lower portion of the inner recessed portion 18e includes a second inner slanting surface 182 arranged to extend radially outward with increasing height. Then, in the inner recessed portion 18e, a first inner slanting surface 181 and the second inner slanting surface 182 are joined to each other. That is, the inner recessed portion 18e includes the first inner slanting surface 181 and the second inner slanting surface 182. In addition, the second inner slanting surface 182 and an opposed surface 17 are joined to each other.

Then, a portion of the stator holding portion 13 which overlaps with the inner recessed portion 18e when viewed in the radial direction is a decreased thickness portion 135. Because of provision of the decreased thickness portion 135, a vibration of a stator core 41 is not easily transferred to a support portion 10, and a reduction in variations in the vibration transferred is achieved. Thus, not only a reduction in vibration is achieved, but also effective vibration control can be accomplished in the support portion 10, that is, in a base 1. As a result, a reduction in vibration of the motor E as a whole is achieved.

While preferred embodiments of the present invention have been described above, the preferred embodiments may be modified in various manners without departing from the scope and spirit of the present invention.

Preferred embodiments of the present invention are applicable to, for example, motors arranged to drive storage apparatuses, such as hard disk apparatuses, optical disk apparatuses, and the like.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a shaft arranged to extend along a central axis extending in a vertical direction, and arranged to rotate about the central axis;
a bearing arranged to rotatably support the shaft;
a hub fixed to an upper end portion of the shaft;
a rotor magnet attached to the hub;
a stator arranged radially opposite to the rotor magnet; and
a support portion arranged to hold the bearing and the stator; wherein
the support portion includes:
a bearing holding portion arranged to extend upward along the central axis, and arranged to hold the bearing with a radially inner surface thereof; and
a stator holding portion being tubular, arranged to project upward from an upper surface of the bearing holding portion, and arranged to hold a radially inner surface of the stator with a radially outer surface thereof; and
an axially lower portion of the stator holding portion includes a decreased thickness portion where a radial thickness of the stator holding portion is smaller than at another portion of the stator holding portion at another axial position.

2. The motor according to claim 1, wherein
the support portion includes an annular outer recessed portion recessed radially inward, at least a portion of the outer recessed portion being defined radially outside of the stator holding portion; and
the decreased thickness portion is arranged to overlap with the outer recessed portion when viewed in a radial direction.

3. The motor according to claim 2, wherein the outer recessed portion includes a first outer slanting surface arranged to extend radially inward with decreasing height.

4. The motor according to claim 3, wherein
the support portion includes a stator contact surface perpendicular to the central axis, and arranged to be in contact with an axially lower surface of the stator; and
in the outer recessed portion, the stator contact surface and the first outer slanting surface are joined to each other.

5. The motor according to claim 3, wherein
the outer recessed portion includes a second outer slanting surface arranged to extend radially inward with increasing height; and
in the outer recessed portion, the first outer slanting surface and the second outer slanting surface are joined to each other.

6. The motor according to claim 2, wherein the outer recessed portion includes an upper surface perpendicular to the central axis, a lower surface perpendicular to the central axis, and a cylindrical joining surface arranged to join the upper surface and the lower surface to each other.

7. The motor according to claim 1, wherein
the support portion includes an annular inner recessed portion recessed radially outward, and defined radially inside of the stator holding portion; and
the decreased thickness portion is arranged to overlap with the inner recessed portion when viewed in a radial direction.

8. The motor according to claim 7, wherein the inner recessed portion includes a first inner slanting surface arranged to extend radially outward with decreasing height.

9. The motor according to claim 8, wherein
the hub includes a labyrinth projecting portion being a tubular body extending downward along the central axis, and arranged radially opposite to each of the bearing and the stator holding portion with a gap therebetween;
the support portion includes an opposed surface arranged opposite to an axially lower end surface of the labyrinth projecting portion on a radially inner side; and
in the inner recessed portion, the opposed surface and the first inner slanting surface are joined to each other.

10. The motor according to claim 8, wherein
the inner recessed portion includes a second inner slanting surface arranged to extend radially outward with increasing height; and
in the inner recessed portion, the first inner slanting surface and the second inner slanting surface are joined to each other.
